(19) United States
(12) Patent Application Publication
(10) Pub. No.: US 2007/0101878 A1
(43) Pub. Date: May 10, 2007

(54) Press unit of a press, and press

(75) Inventor: Peer Dilling, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/495,862

(22) Filed: Jul. 28, 2006

(30) Foreign Application Priority Data
Jul. 30, 2005 (DE) 10 2005 035 875.6

(51) Int. Cl. B41F 5/18

(52) U.S. Cl. 101/180

(57) ABSTRACT

A press unit of a press, in particular a web-fed rotary press, having at least one printing unit, the printing unit having at least one cylinder module comprising a form cylinder and a transfer cylinder and an inking module comprising an inking unit and, preferably, a damping unit. The inking module of the printing unit is arranged laterally beside the cylinder module of the printing unit, it being possible for the inking module of the printing unit to be moved translationally relative to the cylinder module of the printing unit in the axial direction of the cylinders of the cylinder module, in order to move the inking module of the printing unit between a printing position and a maintenance position.

This application claims the priority of German Patent Document No. 10 2005 035 875.6, filed Jul. 30, 2005, the disclosure of which is expressly incorporated by reference herein.

### BACKGROUND AND SUMMARY OF THE INVENTION

The invention relates to a press unit of a press. Furthermore, the invention relates to a press.

Press units of web-fed rotary presses, in particular of newspaper presses or illustration presses, have a plurality of printing units, each printing unit comprising at least a transfer cylinder, a form cylinder and an inking unit and, preferably, a damping unit. Printing units without a damping unit are also known. Furthermore, such press units can have impression cylinders, it being possible for an impression cylinder to interact with one or more transfer cylinders of different printing units. In addition to press units which have such impression cylinders, press units which have no impression cylinders are also known, in such press units without impression cylinders the transfer cylinders of two printing units rolling on each other. The transfer cylinders are also designated rubber covered cylinders and the form cylinders are also designated plate cylinders. The form cylinders or plate cylinders carry printing forms.

Press units of web-fed rotary presses are increasingly being constructed more compactly, that is to say with smaller dimensions. As a result, the installation space available on the press units of a press decreases, that is to say the space available for the positioning or arrangement of the inking units and damping units. Furthermore, in press units having compact constructions, the access to the cylinders, specifically to the form cylinders and transfer cylinders, is made more difficult.

In order to provide a compact construction of press units while simultaneously ensuring good access to the cylinders of the printing units of a press unit, it is already known from German Patent Document No. DE 102 21 330 A1 to move the inking unit and damping unit of printing units of a press unit relative to the cylinders of the printing units, specifically in a direction which runs at right angles to the axial direction of the cylinders of the printing units of a press unit. In the event of such a relative displacement of the inking units and damping units in relation to the cylinders of a press unit, a relatively large free space is needed laterally beside the press unit, into which the inking units and damping units can be moved. Then, if a plurality of such press units are to be combined in a press, this results in a relatively large construction of the press. The same applies to the prior art according to International Publication No. WO 2005/005149 A2.

European Patent Document No. EP 0 638 419 B1 discloses a press unit of a web-fed rotary press which has a plurality of printing units, the inking units and damping units of the press units being combined into modular units, which are arranged above and below the printing units and can be moved in the axial direction of the cylinders of the press unit or printing units. As a result of the arrangement of the inking units and damping units above and below the cylinders of the printing units, a relatively high construction for such a press unit results. If a plurality of such press units are to be combined to form a press, then a passage for persons working on the press is left free between adjacent press units, in order in this way to permit access to the cylinders of the printing units and to the inking units and damping units. This also then results in a relatively large construction for a press.

Taking this as a starting point, the present invention is based on the problem of providing a novel type of press unit which has a compact construction with good access to the cylinders and which, when a plurality of press units are arranged in a press, also permits a compact construction of the press. Furthermore, the invention is based on the problem of providing a corresponding press.

According to the invention, the inking module of the, or each, printing unit is arranged laterally beside the cylinder module of the respective printing unit, it being possible for the inking module of the, or each, printing unit to be moved translationally relative to the cylinder module of the respective printing unit in the axial direction of the cylinders of the cylinder module, in order to move the inking module of the, or each, printing unit between a printing position and a maintenance position.

The press unit according to the invention has a particularly compact construction and, furthermore, when a plurality of such press units are incorporated into a press, permits a compact construction of the press. This applies to presses having horizontal web guidance and also to presses having vertical web guidance of the printing material to be printed. As a result of the modularization of the press unit, the flexibility of the same is also increased since, for example, inking modules can simply be replaced. In the maintenance position of the inking modules, all the modules on the press, including the cylinder modules, are easily accessible, so that maintenance or service work can be carried out more easily and more quickly.

As a result of the novel type of construction of press units, it is also possible, while maintaining the compact construction and good accessibility to the cylinders, to integrate imaging modules, which are used for the imaging and/or de-imaging of rewritable and erasable printing forms, into the press unit. Instead of the imaging modules, modules for carrying out an automatic plate change can also be integrated into the press units.

The, or each, printing unit of the press unit in each case preferably has an imaging module for imaging and/or de-imaging a rewritable and erasable printing form positioned on the form cylinder of the respective printing unit, the imaging module of a printing unit being integrated into the respective printing unit or the press unit in a fixed location, specifically preferably above or below the cylinder module of the respective printing unit. When the inking module of a printing unit is moved into a maintenance position, the form cylinder of the respective printing unit can then be moved in the direction of the imaging module of the respective printing unit.

According to the press of the present invention, within the press units, the inking module of each printing unit is arranged laterally beside the cylinder module of the respective printing unit, within the press units it being possible for the inking module of each printing unit to be moved translationally relative to the cylinder module of the respective printing unit in the axial direction of the cylinders of the cylinder module, in order to move the inking module of the respective printing unit between a printing position and a maintenance position, and press units arranged laterally beside one another being positioned at such a short distance from one another that, when the inking modules are moved into the printing position, two press units arranged beside each other are opposite each other directly without any passage.

Only when at least one inking module of two press units arranged beside each other is moved into the maintenance position is a passage between the two press units exposed, in order to ensure access to the respective cylinder module of the press unit. In this way, safety on the press is also increased, since, during printing operation in the sense of a closed press, no kind of passages which printers operating on the press can enter are present between the press units.

### BRIEF DESCRIPTION OF THE DRAWINGS

Preferred developments of the invention emerge from the following description. Exemplary embodiments of the invention, without being restricted hereto, will be explained in more detail by using the drawings, in which:

FIG. 1 shows a schematic side view of a press unit according to the invention during printing operation in accordance with a first exemplary embodiment of the invention;

FIG. 2 shows the press unit of FIG. 1 in a schematic plan view;

FIG. 3 shows a schematic side view of the press unit according to the invention from FIG. 1 during imaging operation;

FIG. 4 shows the press unit of FIG. 3 in a schematic plan view;

FIG. 5 shows a schematic detail of a press according to the invention in the region of four press units according to FIG. 1 and FIG. 3;

FIG. 6 shows a schematic detail of a press according to the invention in the region of four press units according to a second exemplary embodiment of the invention;

FIG. 7 shows a schematic detail of a press according to the invention in the region of four press units according to a third exemplary embodiment of the invention; and

FIG. 8 shows a schematic detail of a press according to the invention in the region of four press units according to a further exemplary embodiment of the invention.

### DETAILED DESCRIPTION OF THE DRAWINGS

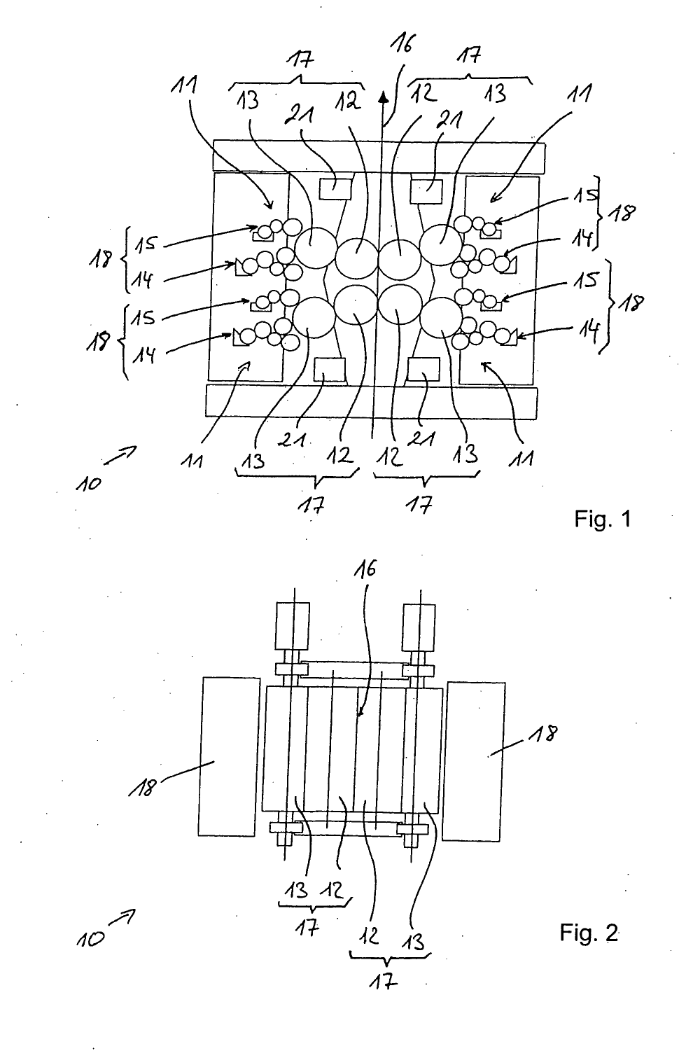

In the following, the present invention will be described in greater detail with reference to FIGS. 1 to 8.

FIGS. 1 to 4 show different views of a press unit 10 according to the invention in a web-fed rotary press according to a first exemplary embodiment of the present invention. The press unit 10 illustrated in FIGS. 1 to 4 has four printing units 11, each of the printing units 11 comprising a transfer cylinder 12, a form cylinder 13, an inking unit 14 and a damping unit 15. In the exemplary embodiment of FIG. 1, in each case two transfer cylinders 12 of the printing units 11 roll on each other, a printing material 16 being moved through the press unit 10 in the vertical direction. Via the inking units 14, printing ink is transported and, via the damping units 15, damping solution is transported in the direction of the form cylinders and applied to printing forms which are arranged on the form cylinders 13. Via the transfer cylinders 12, the printing ink is then transferred to the printing material 16, in order to print the same on both sides in the exemplary embodiment shown in FIGS. 1 to 4.

The form cylinders 13 and transfer cylinders 12 of each printing unit 11 form what is known as a cylinder module 17; the inking units 14 and damping units 15 of the printing units 11 are combined into inking modules 18. In order to ensure the most compact construction of the press unit 10 and good access to the cylinders of the same, it is provided, in the sense of the present invention, to position the inking modules 18 of the printing units 11 laterally beside the cylinder modules 17 of the printing units 11. Accordingly, the inking unit 14 and damping unit 15 of the inking modules 18 are in each case arranged laterally beside the form cylinder 13 of the respective printing unit 11. The inking modules 18 of the printing units 11, as can be gathered in particular from FIG. 4, can be displaced relative to the cylinder modules 17 of the printing units 11, specifically in the axial direction of the transfer cylinders 12 and form cylinders 13.

FIGS. 1 and 2 show the inking modules 18 of the printing units 11 in a printing position, in which the inking unit 14 and the damping unit 15 of the inking modules 18 are set against the respective form cylinder 13 of the respective printing unit 11.

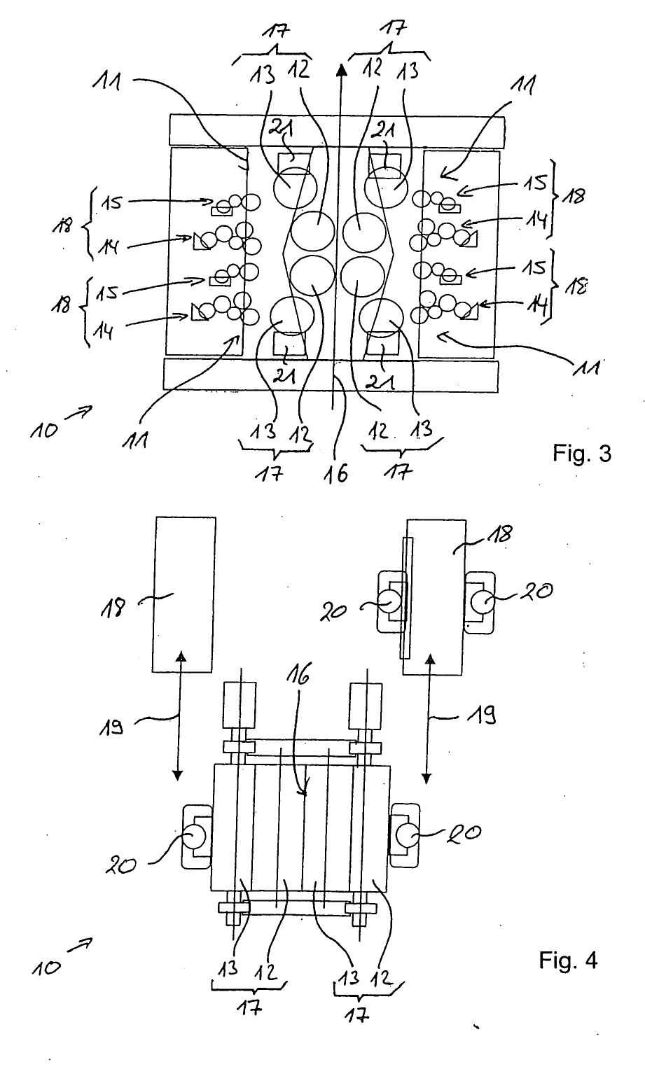

On the other hand, FIGS. 3 and 4 show the press unit 10 in a maintenance position of the inking modules 18, in which the same have been displaced translationally with respect to the cylinder modules 17 of the printing units 11 of the press unit 10 in the sense of the double arrows 19 and, accordingly, are set off the form cylinders 13 of the printing units 11. In the position shown in FIG. 4, both the cylinder modules 17 and the inking modules 18 are easily accessible to persons 20 working on the press for maintenance work or setup work.

In the exemplary embodiment shown in FIGS. 1 to 4, the inking modules 18 of printing units 11 arranged above one another can in each case be moved jointly relative to the cylinder groups 17 of the respective printing units 11. This means that the inking modules 18 of the printing units 11 illustrated in FIGS. 1 and 3 on the left-hand side of the printing material web 16 can be moved jointly in the translational direction. Likewise, the inking modules 18 of the printing units 11 illustrated on the right-hand side of the printing material 16 can be moved jointly in the translational direction with respect to the cylinder modules 17 of these printing units 11.

A separate imaging module 21 for each printing unit 11 is integrated into the press unit 10 of FIGS. 1 to 4. Each of the imaging modules 21 is used for de-imaging and imaging rewritable and erasable printing forms positioned on the form cylinders 13. The press unit 10 illustrated in FIGS. 1 to 4 is accordingly designed as a “computer to press/direct imaging” press unit, as it is known, which operates with rewritable and erasable printing forms. The de-imaging and imaging of the printing forms positioned on the form cylinders 13 is carried out when an inking module 18 is set off the cylinder module 17 of the respective printing unit 11 and has accordingly been moved into the maintenance position. In this case, the form cylinder 13 can then be set against the fixed-location imaging module 21 (see FIG. 3), in order in this way to de-image and to re-image the printing form positioned on the form cylinder 13. Instead of the imaging modules, modules for carrying out an automatic plate change can also be integrated into the press units.

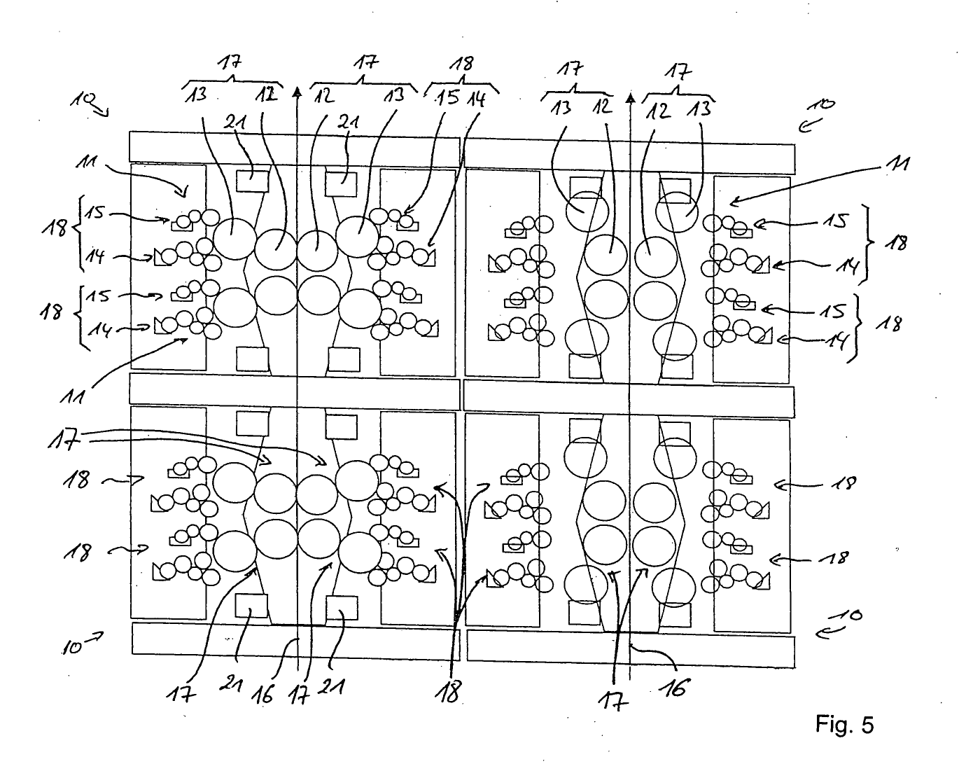

FIG. 5 shows a detail from a press according to the invention in the region of four press units 10, the press units 10 being constructed in the sense of FIGS. 1 to 4. In the arrangement of FIG. 5, in each case two press units 10 are positioned one above the other, and two press units 10 are positioned beside each other. As a result of the configuration of the press units 10 according to the invention, a particularly compact and space-saving arrangement of the press units 10 within a press is possible.

It should be pointed out that the two left-hand press units 10 of the arrangement of FIG. 5 are illustrated in printing operation, that is to say in the illustration analogous to FIG. 1, and the two right-hand press units 10 are illustrated in imaging operation, that is to say in the illustration analogous to FIG. 3.

As can be gathered from FIG. 5, press units 10 positioned beside one another are positioned at such a small distance from one another that, with the inking modules 18 moved into the printing position, two press units 10 arranged beside each other are opposite each other directly, so that no passage for persons working on the press is formed between two press units 10 positioned laterally beside each other.

Only when at least one inking module 18 has been moved translationally with respect to a cylinder module 17 of a printing unit 11 of a press unit 10, into the maintenance position of the same, is a passage between two adjacent press units 10 exposed, so that a person or a printer is able to enter a free space between two adjacent press units 10.

In the exemplary embodiment of FIG. 5, between two press units 10 arranged laterally beside each other, the inking modules 18 of the printing units 11 of the press units 10 arranged beside each other are arranged directly beside each other. When in at least one of the press units 10 an inking module 18 is displaced or moved translationally in relation to the cylinder module 17 into a maintenance position, a free space is exposed between the press units 10. When two adjacent inking modules 18 of two press units 10 arranged beside each other are moved into the maintenance position, a passage or free space, which corresponds to the dimension of the two adjacent inking modules 18, is exposed between the press units 10.

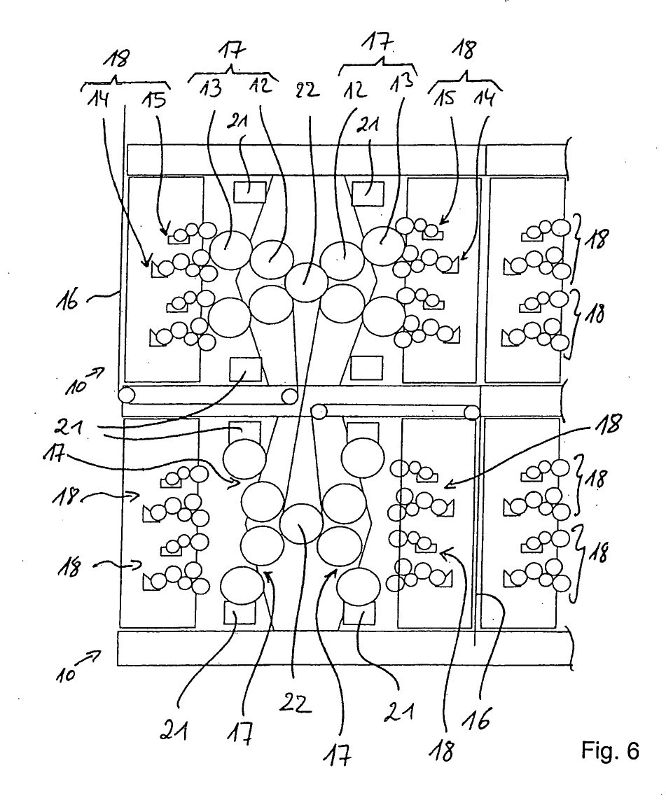

FIGS. 6, 7 and 8 show further exemplary embodiments of press units according to the invention and details from presses according to the invention which all in-turn make use of the idea according to the invention, that inking modules 18 of the printing units 11 of the press units 10 are arranged laterally beside the cylinder modules 17 of the respective printing units 11, and that the inking modules 18 of the printing units 11 can be moved translationally relative to the cylinder modules 17 of the printing units 11 in the axial directions of the form cylinders 13 and transfer cylinders 12. In order to avoid unnecessary repetitions, therefore, the same reference numbers are used for the same subassemblies and, in the following text, only the details by means of which the exemplary embodiments of FIGS. 6 to 8 differ from the exemplary embodiment of FIGS. 1 to 5 will be discussed.

FIG. 6 shows a detail from a press in the region of four press units 10, the press units 10 of the exemplary embodiment of FIG. 6 in each case comprising an impression cylinder 22. All the transfer cylinders 12 of the printing units 11 of a press unit 10 in this case roll on a common impression cylinder 22, the printing material 16 to be printed being moved through between the transfer cylinders 12 and the impression cylinder 22. The exemplary embodiment of FIG. 6, just like the exemplary embodiment of FIGS. 1 to 5, also relates to a press having a vertical web run of the printing material web to be printed, that is to say a web-fed rotary press constructed as a newspaper press.

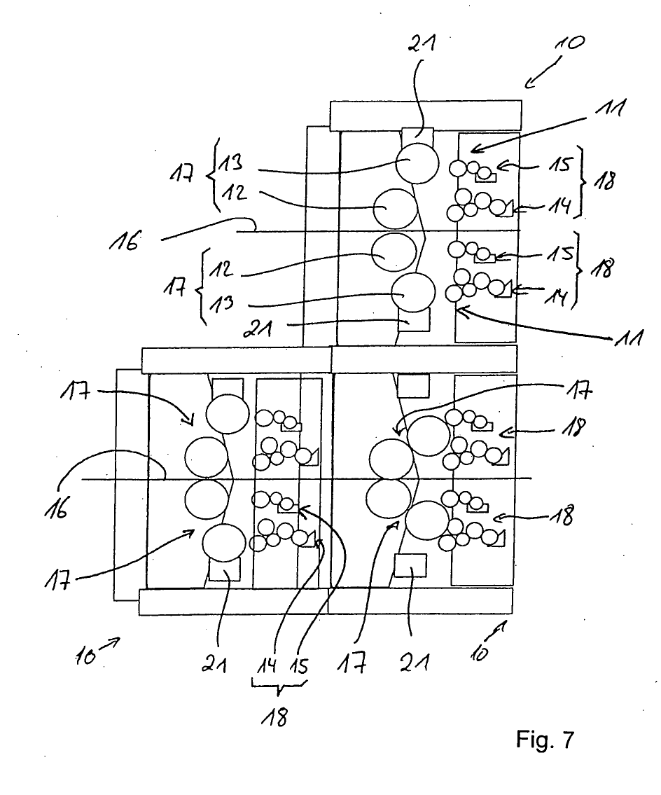

FIG. 7 shows a detail from a press according to the invention in the region of three press units 10 according to the invention, each of the press units 10 of the exemplary embodiment of FIG. 7 comprising two printing units 11. In this case, once more the transfer cylinders 12 of two printing units 11 roll on each other, a printing material 16 being transported between two transfer cylinders 12 with a horizontal web run. The arrangement of FIG. 7 is accordingly a detail from a web-fed rotary press constructed as an illustration press.

In the press units 10 of the exemplary embodiment of FIG. 7, the inking modules 18 are also positioned laterally beside the cylinder modules 17 of the printing units 11 and can be moved translationally with respect to the cylinder modules 17 in the axial direction of the cylinders. In this way, the inking modules 18 can be moved between a maintenance position and a printing position. In a position moved into the printing position, the inking modules 18 are set against the cylinder modules 17 of the printing units 11. On the other hand, in a position moved into the maintenance position, the inking modules 18 are set off the cylinder modules 17, in this case it being possible for the form cylinders 13 to be set against imaging modules 21 of the printing units 11, in order to de-image and to image printing forms positioned on the form cylinders 13.

In the arrangement of FIG. 7, the two lower press units 10 positioned beside each other are also positioned at such a short distance from each other that, when the inking modules 18 are moved into the printing position, no passage is formed between the two press units 10 arranged beside each other. Only when the inking modules 18 of a press unit 10 are displaced in the axial direction of the cylinder modules 17 of the respective press unit 10 into a maintenance position is a passage between two press units 10 arranged beside each other exposed, so that the cylinder modules 17 and inking modules 18 are then accessible for maintenance work or setup work.

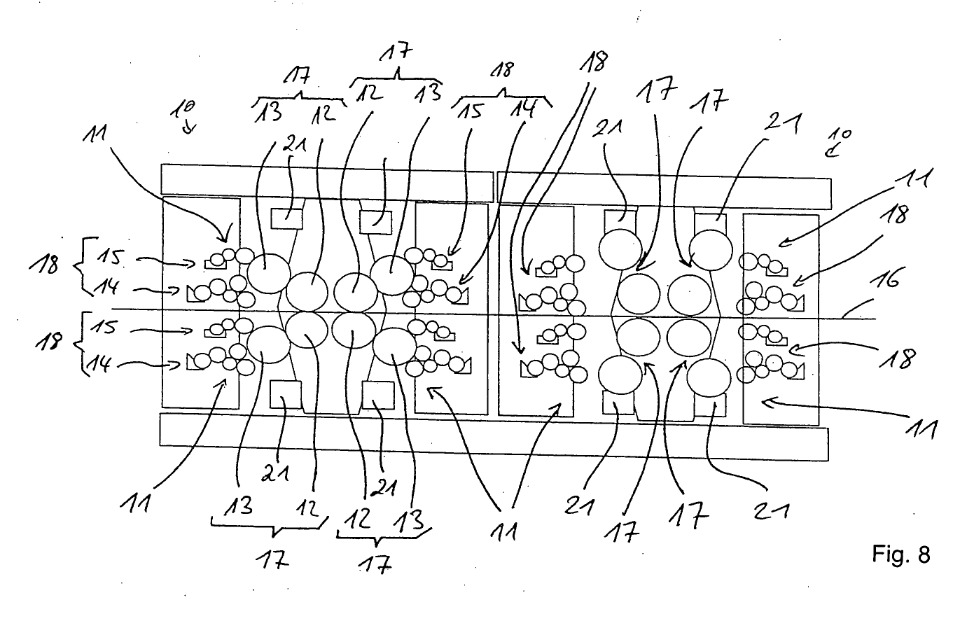

A further detail from a web-fed press constructed as an illustration press, in the region of two press units 10, is shown by FIG. 8. The press units 10 of the exemplary embodiment of FIG. 8 correspond substantially to the press units 10 of the exemplary embodiment of FIGS. 1 to 4. The single difference is that in FIG. 8 there is a horizontal web run of the printing material web to be printed, and in FIGS. 1 to 4 there is a vertical web run of the printing material web to be printed. In order to avoid unnecessary repetitions, reference can accordingly also be made here to the above explanations.

### LIST OF REFERENCE SYMBOLS

10 Press unit
11 Printing unit
12 Transfer cylinder
13 Form cylinder
14 Inking unit
15 Damping unit
16 Printing material
17 Cylinder module
18 Inking module
19 Direction of movement
20 Person
21 Imaging module
22 Impression cylinder

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A press unit of a press, in particular a web-fed rotary press, having at least one printing unit, the printing unit having at least one cylinder module comprising a form cylinder and a transfer cylinder and an inking module comprising an inking unit and a damping unit, wherein the inking module of the printing unit is arranged laterally beside the cylinder module of the printing unit, and wherein the inking module of the printing unit is movable translationally relative to the cylinder module of the printing unit in an axial direction of the form and transfer cylinders of the cylinder module between a printing position and a maintenance position.

2. The press unit according to claim 1, wherein a plurality of printing units, each printing unit having a cylinder module and an inking module, wherein the inking modules of the printing units are arranged above one another and are movable translationally together relative to the cylinder modules of the respective printing units in the axial direction of the cylinders of the cylinder modules.

3. The press unit according to claim 1, wherein the printing unit has an imaging module for imaging and/or de-imaging a rewritable and erasable printing form positioned on the form cylinder of the printing unit, wherein the imaging module of the printing unit is integrated into the printing unit in a fixed location.

4. The press unit according to claim 3, wherein when the inking module of the printing unit is moved into the maintenance position, the form cylinder of the printing unit is movable in a direction of the imaging module.

5. A press, in particular a web-fed rotary press, having a plurality of press units, each press unit having a plurality of printing units, each printing unit having at least one cylinder module comprising a form cylinder and a transfer cylinder and an inking module comprising an inking unit and a damping unit, wherein the inking module of each printing unit is arranged laterally beside the cylinder module of the respective printing unit, and wherein the inking module of each printing unit is movable translationally relative to the cylinder module of the respective printing unit in an axial direction of the form and transfer cylinders of the cylinder module between a printing position and a maintenance position, and wherein press units arranged laterally beside one another are positioned at such a short distance from one another that, when the inking modules are moved into the printing position, two press units arranged beside each other are opposite each other directly without any passage between the two press units.

6. The press according to claim 5, wherein when adjacent inking modules of two press units arranged beside each other are moved into the printing position, the inking modules of the respective press units are opposite each other directly and without any passage between the inking modules.

7. The press according to claim 5, wherein when adjacent inking modules of two press units arranged beside each other are moved into the maintenance position, a passage between the two press units is exposed to provide access to the respective cylinder modules of the press units.

8. The press according to claim 5, wherein when one of adjacent inking modules of two press units arranged beside each other is moved into the maintenance position, a passage between the two press units is exposed to provide access to the respective cylinder module of the press unit.

9. The press according to claim 5, wherein inking modules of printing units are arranged above one another and are movable translationally together relative to the cylinder modules of the respective printing units in the axial direction of the cylinders of the cylinder modules.

10. The press according to claim 5, wherein each printing unit has an imaging module for imaging and/or de-imaging a rewritable and erasable printing form positioned on the form cylinder of the printing unit, wherein the imaging module of the printing unit is integrated into the printing unit in a fixed location.

11. The press according to claim 10, wherein when the inking module of the respective printing unit is moved into the maintenance position, the form cylinder of the respective printing unit is movable in a direction of the imaging module.

12. A press unit of a press, comprising:
a printing unit, including:
a cylinder module including a form cylinder and a transfer cylinder; and
an inking module including an inking unit and a damping unit;
wherein the inking module is disposed laterally beside the cylinder module, and wherein the inking module is movable translationally relative to the cylinder module in an axial direction of the form and transfer cylinders between a printing position and a maintenance position.

13. The press unit according to claim 12, wherein a longitudinal axis of the inking module is parallel to a longitudinal axis of the cylinder module.

14. The press unit according to claim 13, wherein the inking module is disposed in a perpendicular direction from the longitudinal axis of the cylinder module.

15. The press unit according to claim 12, wherein when the inking module is in the printing position the inking module is disposed adjacent to the cylinder module, and wherein when the inking module is in the maintenance position the inking module is disposed beyond a longitudinal end of the cylinder module.

16. A method of operating a press unit, wherein the press unit includes:
a printing unit, including:
a cylinder module including a form cylinder and a transfer cylinder; and
an inking module including an inking unit and a damping unit;
wherein the inking module is disposed laterally beside the cylinder module, comprising the steps of:
translationally moving the inking module in an axial direction of the cylinder module such that the inking module is disposed at a longitudinal end of the cylinder module;
performing a maintenance procedure on the inking module or cylinder module after the inking module is disposed at the longitudinal end of the cylinder module;
translationally moving the inking module to a position laterally adjacent to the cylinder module; and
performing a printing procedure with the inking module and the cylinder module after the inking module is moved to the position laterally adjacent to the cylinder module.

17. The method according to claim 17, further comprising the steps of:
moving the form cylinder toward an imaging module when the inking module is disposed at the longitudinal end of the cylinder module; and
de-imaging or imaging the form cylinder with the imaging module.
